(19) United States
(12) Patent Application Publication
(10) Pub. No.: US 2024/0273406 A1
(43) Pub. Date: Aug. 15, 2024

(54) METHODS AND APPARATUS FOR BOUNDED LINEAR COMPUTATION OUTPUTS

(71) Applicant: Essential Knowledge Systems, LLC, Little Elm, TX (US)

(72) Inventor: Beddhu Murali, Little Elm, TX (US)

(73) Assignee: Essential Knowledge Systems, LLC, Little Elm, TX (US)

(21) Appl. No.: 18/437,888

(22) Filed: Feb. 9, 2024

Related U.S. Application Data
(60) Provisional application No. 63/484,734, filed on Feb. 13, 2023.

(51) Int. Cl. G06N 20/00

(52) U.S. Cl. CPC G06N 20/00; G06N 3/084

(57) ABSTRACT

This invention presents a method for data modeling in multivariate regression models and neural networks. It replaces the vertical distance of data points from a hyperplane with the normal distance, ensuring finite values even when the vertical distance becomes infinite, provided the data points have a finite magnitude. In the context of neural networks, a hidden output coordinate dimension is utilized on a per hyperplane basis, allowing the introduction of any desired surface as a hidden surface. The invention also includes methods to limit the unbounded growth of weight components, addressing issues of numerical instability in machine learning models.

### CROSS-REFERENCE TO RELATED APPLICATIONS

This application claims the benefit of and priority to U.S. Provisional Patent Application No. 63/484,734 titled “Methods and Apparatus for Bounded Linear Computation Outputs” filed on Feb. 13, 2023, and is hereby incorporated by reference in its entirety.

### BACKGROUND

### Field of the Art

This specification relates to Artificial Intelligence, Machine Learning and Data Modeling.

### Discussion of the State of the Art

The rapid advancement of artificial intelligence (AI) has led to increasingly large neural network models that demand massive computing resources to train and run. Some AI experts have stated that the future capabilities of AI depend on an energy breakthrough because current projections underestimate the vast amounts of power future AI systems will consume.

Some have attempted to address the growing computing demands of AI systems in a few ways. One method is using “teacher-student” models, where a small “student” model tries to mimic the outputs of a large, fully-trained “teacher” model. This allows the small student model to be used efficiently for inferences. Similarly, model compression techniques like (Q)LoRA reduce the number of parameters in a dense teacher model to create a lean student model.

However, these prior attempts fail to fully solve the underlying problem. Teacher-student models and compression techniques like (Q)LoRA still require training an initial, massive model that consumes extensive computing resources. So while they improve efficiency for inference, they do not address the difficult problem of exploding demand during the resource-intensive training process. The core challenge of developing powerful AI without overloading computing infrastructure therefore persists unabated. Solving this issue is critical given projections that AI will need more computing over the next decade than what exists in the world today.

Additionally, the field of artificial intelligence and machine learning sometimes involves the use of multivariate linear regression models as loss functions, which are frequently solved using iterative methods. However, a significant issue with these methods is that the convergence of the iterative scheme is heavily influenced by the initial values selected for the weights. This problem arises due to the potential for the vertical distance between a hyperplane and data points to grow without limit.

Moreover, in the context of artificial intelligence and machine learning, linear computations are commonly used in both hidden layers and output layers. These computations are typically followed by a non-linear activation, such as Sigmoid or ReLU. The results of these activations then serve as inputs to the subsequent layer. The weights and biases in these methods are usually initialized randomly and updated iteratively. However, these weights and biases can grow without any bounds, which results in the output from the layer also being unbounded. This unbounded growth leads to the well-known problems of vanishing and exploding gradients, which can significantly hamper the performance of machine learning models.

Past attempts to address these problems have involved restarting the iterative methods for multivariate linear regression with new initial values. However, this approach does not fundamentally address the issue of unbounded growth in the weights and biases.

In the literature, the vanishing gradient problem has been attributed to the use of sigmoid and tanh activation functions. This has led to the development of alternative activation functions, such as the ReLU activation. However, the use of ReLU has been associated with premature cessation of learning, leading to the development of the dropout method. Furthermore, to make the resulting scheme converge faster and more stably, methods such as batch normalization and layer normalization have been developed. Nevertheless, these methods have not fully resolved the issues associated with unbounded growth in the weights and biases, and the resulting problems of vanishing and exploding gradients.

### SUMMARY

The present invention comprises methods and systems for efficiently training machine learning (ML) and artificial intelligence (AI) models using significantly fewer computational resources and less data. The techniques retain information more effectively across neural network layers and introduce stability that accelerates convergence during training.

In particular, the invention bounds linear computations in model architectures to overcome issues with unrestricted gradient and weight explosion that hinder performance. It allows models to learn accurately using as little as 15 times less training data and 15 times fewer processor cycles, reducing computing costs. The resulting models are smaller in size, faster in execution speeds, and require fewer processor cycles during inference—generating major resource savings.

The techniques are universally compatible with all existing ML/AI frameworks including PyTorch, TensorFlow, Keras etc. They can be applied to any current model architecture with no restrictions on orientation or rotations. The formulations feature simpler gradients, easier implementation, and stable, accelerated convergence trajectories suited even for emerging domains like physics-inspired ML.

Notably, the invention avoids the vanishing gradient problem prevalent in deep neural networks by replacing the commonly used vertical distance calculation between data points and hyperplanes with a normal distance metric. Since normal distances remain bounded even with infinite weight growth, this protects information propagation across layers. In other words, the invention addresses the issue of unbounded growth in the weights and biases, and the resulting problems of vanishing and exploding gradients, by replacing the vertical distance of data points from a hyperplane with the normal distance to the hyperplane. This approach is motivated by the fact that the normal distance to a hyperplane remains finite, even when the vertical distance becomes infinite, as long as the data points maintain a finite magnitude.

In the case of linear layers used in neural networks, the invention employs a hidden output coordinate dimension on a per hyperplane basis. This allows for the introduction of any desired surface as a hidden surface, the simplest of which is a hyperplane. Additionally, the invention presents methods that limit the unbounded growth of weight components, further enhancing the stability and performance of the models.

Each row of the weight matrix, along with the corresponding bias term, is combined with a hidden output dimension to form an n+2 dimensional space, where n is the column size of the weight matrix. The value of the hidden output variable can be specified arbitrarily or learned and is used to enforce stability. The normal distance of these data points from the hyperplane formed by the weight vector and the bias term forms the output from the linear operation in this invention.

By using the normal distance to a hyperplane, the invention ensures that the outputs from linear layers remain finite, even when weights and biases are unbounded. This allows these outputs to be fed to any activation function, including sigmoid and tanh, without encountering the vanishing gradient problem.

The benefits of this invention include increased flexibility in the choice of activation function, enhanced numerical stability of the algorithm, and the potential to use larger learning rates. The invention also eliminates the need for dropouts and other normalization strategies, reducing the associated parameter count. Furthermore, it allows for achieving a given loss using fewer layers, potentially simplifying the architecture and improving the efficiency of the models.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a high-level system for methods and apparatus for bounded linear computation outputs in accordance with an exemplary embodiment of the invention.

FIG. 2A illustrates an inference system for bounded linear computation outputs in accordance with an exemplary embodiment of the present invention.

FIG. 2B illustrates a training system for bounded linear computation outputs in accordance with an exemplary embodiment of the present invention.

FIG. 3A illustrates an exemplary process for bounded linear computation outputs according to one embodiment of the invention.

FIG. 3B further illustrates an exemplary process for bounded linear computation outputs according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

FIG. 8 illustrates the problem with classical linear regression.

FIG. 9 shows the advantage of the normal distance-based method.

FIG. 10 shows a schematic of a Neural Network (NN), showing the input layer, output layer, and one or more hidden layers.

FIG. 11 illustrates a method of computing normal distances to hyperplanes from a previous layer to a linear regression output layer in a (n+2) dimensional space, where n is the number of nodes in the previous layer excluding the bias node(s).

FIG. 12 illustrates a method to compute normal distances to hyperplanes between two generic layers given that the right layer is not a linear regression layer, in a (n+1) dimensional space, where n is the number of nodes in the previous layer excluding the bias node.

FIG. 13 illustrates a schematic of a hyperplane and its normal before and after enabling quadrant flipping.

FIG. 14 illustrates a schematic of a hyperplane and its normal before and after quadrant flipping.

FIG. 15 illustrates a schematic of an exemplary system with one or more independent computing subsystems.

FIG. 16 illustrates a schematic of an exemplary node which may comprise of Processing Units, Memory Units, Storage Units and Networking Units.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Conceptual Architecture

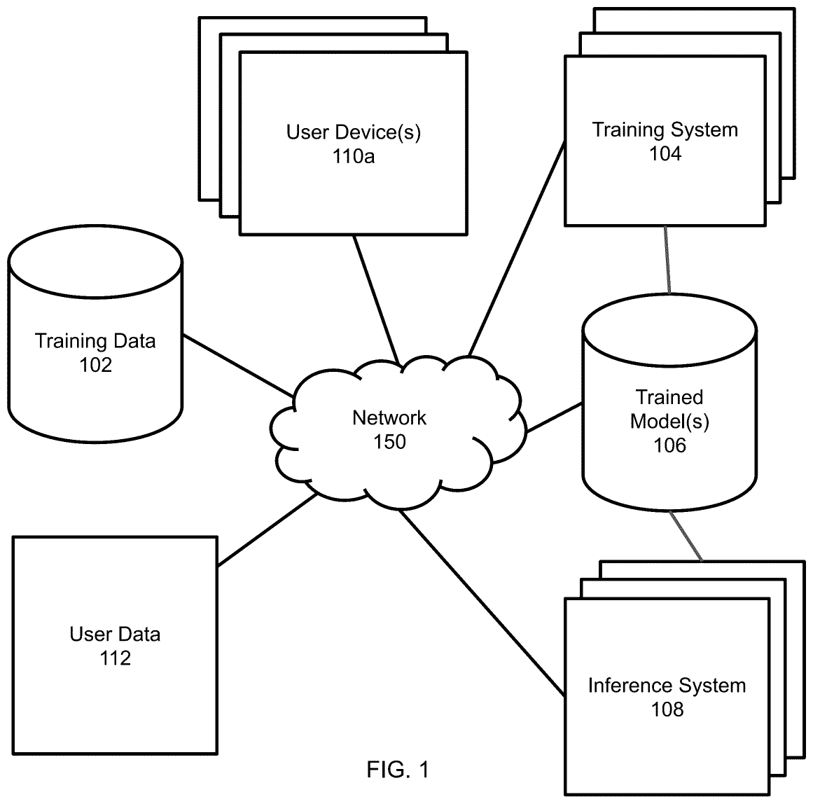

FIG. 1 illustrates an exemplary embodiment of methods and apparatus for bounded linear computation outputs according to one embodiment. The system includes an artificial intelligence inference system 108, a training system 104, user device(s) 110, and storage systems for training data 102, trained models 106, user data 112, and a network 150 over which the various systems communicate and interact. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention.

The artificial intelligence inference system 108 is a component of the invention disclosed herein. It is designed to interact with user devices 110 over a network 150. A function of the system 108 is to run the trained models 106 based on the input received from the user devices 110. The trained models 106 are composed of layers created using the novel method described in the invention, which replaces the vertical distance of data points from a hyperplane with the normal distance to the hyperplane in linear computations.

Upon receiving the input from user devices 110, system 108 processes this information using the trained models 106. The models employ the unique method of data modeling, which not only ensures finite values for computations but also limits the unbounded growth of weight components. This results in more efficient and stable computations.

After processing the input data, system 108 generates output, which is then sent back to the user devices 110 over the network 150. This output is the result of the computations performed by the trained models and is based on the input received from the user devices.

In addition to processing input and generating output, system 108 also stores the input from users and outputs to users in user data 112. This storage of data allows for potential future references and can be used for further analysis or improvement of the trained models.

As an alternative to the described setup, system 108 may, in one embodiment, interact with user devices 110 through direct connections, bypassing the need for a network 150.

Moreover, the storage of user data 112 could be optional or configured based on user preferences or regulatory requirements. Furthermore, while the trained models 106 are described as being composed of layers created using the present invention, they could potentially incorporate other types of layers or methods, provided they are compatible with the overall functioning of the system 108. The training system 104 operates in an offline mode, independent of user interaction. It is designed to train artificial intelligence models utilizing data sourced from the training data system 102. The frequency of its operation can be tailored to specific needs, with options to run it on an as-needed basis or at regular intervals. In various embodiment, the artificial intelligence inference system 108 is embodied in a server as described herein.

The artificial intelligence models that the training system 104 trains are composed of layers. These layers are created using the methods detailed in this invention, which involve replacing the vertical distance of data points from a hyperplane with the normal distance to the hyperplane in linear computations, employing a hidden output coordinate dimension on a per hyperplane basis, and implementing methods that limit unbounded growth of weight components.

Once the training system 104 has completed the training process, the resultant trained models are stored in the storage system for trained models 106. This storage allows for the subsequent use of these models in the artificial intelligence inference system 108.

As an alternative, the training system 104 may, in one embodiment, operate in an online mode, allowing for real-time updates and adjustments to the artificial intelligence models. Additionally, while the current method involves storing the trained models in the storage system for trained models 106, other storage options could be explored, such as cloud-based storage solutions or distributed storage systems, depending on the specific requirements and constraints of the system. User devices are equipped with software that facilitates their interaction with the artificial intelligence inference system. This interaction primarily involves the transmission and reception of data. The software on the user devices initiates communication with the artificial intelligence inference system by sending data, which could be user inputs or other relevant information.

This data is processed by the artificial intelligence inference system, which runs trained models on the received data and generates corresponding outputs. These outputs are then sent back to the user devices. The software on the user devices receives this output data and can use it for various purposes, such as presenting results to the user or triggering other processes within the device.

While the current setup involves user devices interacting with the artificial intelligence inference system through a dedicated software, alternative methods of interaction could be used. For instance, user devices could interact with the system through a web interface or a mobile application. Additionally, instead of one-way communication where user devices only send data, a two-way communication setup could be implemented where user devices can also send feedback or queries to the artificial intelligence inference system.

User device(s) 110 include, generally, a computer or computing device including functionality for communicating (e.g., remotely) over a network 150. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

In one embodiment, users can interact with user devices using voice which will be transcribed to text and sent to the server.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

### Artificial Intelligence Inference Subsystem

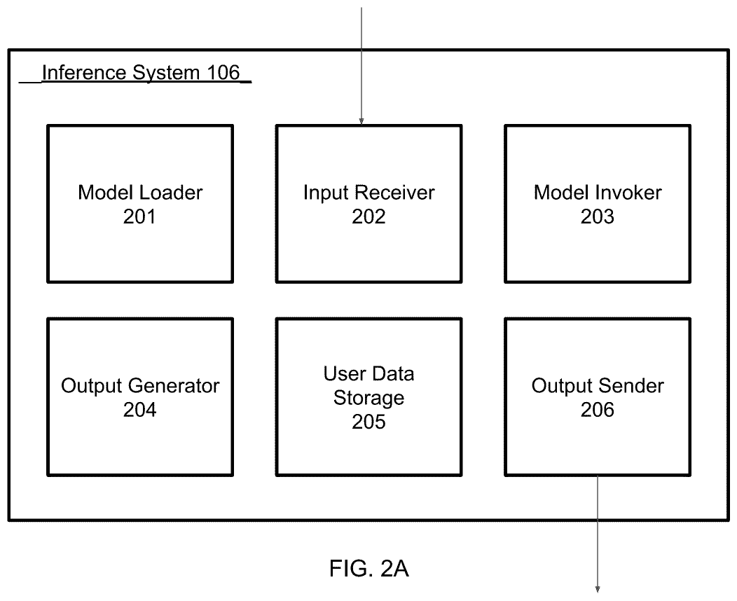

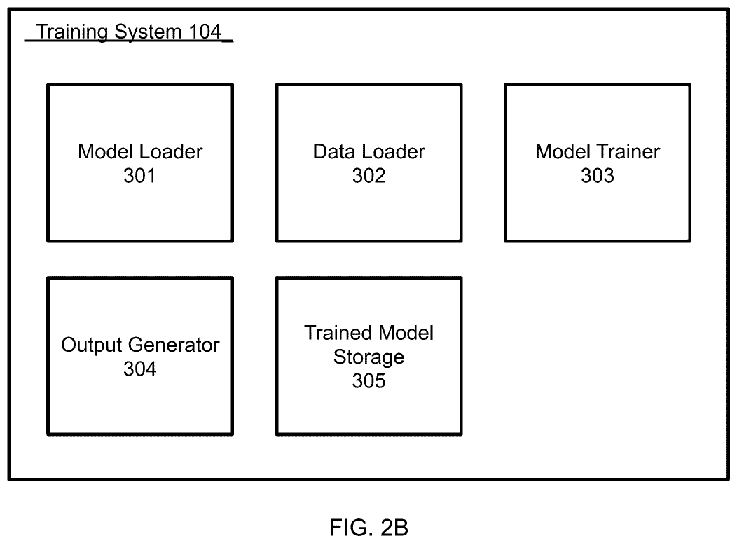

FIGS. 2A and 2B illustrate an exemplary embodiment of the methods and apparatus for bounded linear computation outputs. More specifically, FIG. 2A represents one embodiment of the artificial intelligence inference system. It loads the trained model that uses the present invention and awaits user input. Once a user input arrives it feeds that to the model and generates an output. The system then stores user input and model output as user data and then sends model output back to the user. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Upon initiation of the system, the Model Loader 201 is engaged to retrieve the trained model from its storage location. This process involves reading the data of the trained model from the storage and loading it into the system's memory for use. The Model Loader 201 ensures that the trained model is readily accessible for processing user input.

Following the successful loading of the trained model, the system enters a loop where it invokes the Input Receiver 202. The primary function of the Input Receiver 202 is to continually wait for and accept user input. This may involve listening for incoming data from a user interface or other input devices, and processing this data into a format that can be used by the trained model.

Once the Input Receiver 202 has received and processed the user input, this data can be passed to the loaded trained model for further processing. The loop continues to run, allowing for continuous receipt and processing of user input.

As an alternative to the Model Loader 201, the trained model could potentially be loaded into the system's memory at the time of system boot-up, or kept in a ready state in a cache memory for faster access. For the Input Receiver 202, alternatives could include a polling mechanism where the system checks for user input at regular intervals, or an event-driven approach where the system responds to user input events as they occur. Upon receiving a user input, the Input Receiver transfers this data to the Model Invoker 203. The Model Invoker 203 is responsible for running the loaded trained model on the received user input. This involves feeding the user input into the trained model and executing the model's algorithms to generate an output.

Once the Model Invoker 203 has run the model and obtained an output, this output data is then passed to the Output Generator 204. The Output Generator 204 also receives the original user input from the Model Invoker 203. With both the model output and the user input, the Output Generator 204 can proceed to generate a comprehensive output that can be presented to the user or used by other components of the system.

In other alternatives, the Model Invoker 203 is designed to run multiple models in parallel or in sequence, depending on the complexity of the user input and the requirements of the system. The Output Generator 204, on the other hand, is designed to format the output in various ways, such as text, graphical representations, or other formats suitable for the user or the system's requirements. The Output Generator 204 is designed to receive both the user input and the model output. Upon receipt, it has the capability to optionally post-process the model output. This post-processing could involve various transformations or modifications to the model output, such as formatting, normalization, or other types of data manipulation, depending on the requirements of the system.

Once the Output Generator 204 has completed any necessary post-processing, it transfers the results to the User Data Storage Unit 205. The User Data Storage Unit 205 is responsible for storing the results in a manner that allows for efficient retrieval and use in the future. This could involve writing the results to a database, a file, or other types of storage mediums.

As an alternative, the Output Generator 204 could potentially bypass post-processing under certain conditions, such as when the model output is already in a suitable format. The User Data Storage Unit 205 could also be designed to store the results in different ways, such as in a cloud storage service, or it could employ different strategies for data organization and retrieval, such as indexing or data partitioning. The User Data Storage Unit 205 is designed to receive and store the user input and model output. The data is stored as user data in a permanent storage medium, which could be a hard disk, solid state drive, or other types of non-volatile storage devices. This storage process ensures that the user data is preserved for future reference, even when the system is not powered.

Once the user data is securely stored, the User Data Storage Unit 205 then passes the model output to the Output Sender 206. The Output Sender 206 is responsible for delivering the model output to its intended destination, which could be a user interface, another system or subsystem, or a remote server.

In other embodiments the User Data Storage Unit 205 may be designed to use various types of databases or file systems to organize the stored user data. It could also employ different data redundancy or backup strategies to ensure the integrity and availability of the user data. The Output Sender 206, on the other hand, could use different protocols or methods for sending the model output, such as HTTP, FTP, or other types of network protocols, depending on the requirements of the system and the destination of the model output. The Output Sender 206 is designed to receive the model output from the User Data Storage Unit 205. Upon receipt of this data, the Output Sender 206 initiates the process of sending this data back to the user who provided the corresponding input. This could involve transmitting the data over a network, displaying it on a user interface, or sending it to a user-specified destination.

The process of sending the data back to the user ensures that the user receives the results of their input processed by the model. The Output Sender 206 is designed to handle this process efficiently, ensuring that the user receives the model output in a timely manner.

In other embodiments, the Output Sender 206 could use various methods for sending the model output back to the user. For instance, it could use different network protocols, such as TCP/IP, UDP, or others. It could also use different data formats or encoding schemes to ensure that the model output is correctly interpreted by the user's system. Additionally, the Output Sender 206 could be designed to handle different types of user interfaces or output devices, such as screens, printers, or other types of hardware.

FIG. 2B shows an exemplary embodiment of the Training System 104. It loads the model whose layers are created using the present invention, initializes learnable model parameters (layer weights and biases) randomly and loads the training data. It trains the model iteratively using all the training data in each iteration and updating the model weights using a preselected strategy. It stores intermediate values of model parameters using a validation strategy and stops training using another preselected strategy. It chooses the best set of model parameters among the sets of parameters using a preselected strategy stored by the validation strategy and stores the final model parameters to Trained Models 106. The process steps described herein may be performed in association with a system such as that described in FIG. 1 and/or FIG. 2 above or in association with a different system. The process may comprise additional steps, fewer steps, and/or a different order of steps without departing from the scope of the invention as would be apparent to one of ordinary skill in the art.

The Model Loader 301 is a component designed to load the model from storage. The model it loads is unique, consisting of layers that are created using the present invention. In one embodiment, the Model Loader 301 randomly initializes the trainable model parameters. This random initialization can provide a starting point for the learning process, which can then adjust these parameters to improve the model's performance.

However, the initialization of the trainable model parameters is not limited to random methods. Other strategies can also be used depending on the specific requirements or characteristics of the model or the data. For instance, the trainable model parameters could be initialized based on previous learning experiences, using a pre-training method. They could also be initialized using a method that takes into account the distribution of the input data, or a method that is designed to promote certain desirable properties in the model, such as sparsity or robustness.

In terms of storage, the model could be stored in various types of storage mediums, such as hard disks, solid state drives, or cloud storage services. The Model Loader 301 could be designed to work with different types of file formats or data structures used to represent the model, such as binary files, text files, or database records. The Data Loader 302 is a component that is designed to load the training data required for training the model. The process of loading the training data is guided by a predetermined strategy. One such strategy is to load the data in batches. This batch loading strategy can help manage the memory usage of the system and can also facilitate the use of certain training algorithms that operate on batches of data.

However, the batch loading strategy is just one of the many possible strategies that the Data Loader 302 could employ, as would be understood by a person of ordinary skill in the art. For instance, it could also load the entire dataset at once, if the size of the dataset and the memory capacity of the system allow. Alternatively, it could load the data in a streaming manner, continuously loading small portions of the data as the training process progresses.

In one embodiment, the Data Loader 302 is designed to handle different types of data sources, such as local files, remote servers, or databases. It could support different data formats, such as CSV, JSON, or binary formats. Additionally, it includes functionality for preprocessing the data, such as normalization, transformation, or augmentation, depending on the requirements of the model and the characteristics of the data. The Model Trainer 303 is a component designed to run an iterative process that uses the training data both as inputs and, when required by the modeling method, as ground truths to update the model weights. Each iteration involves using all the training data, possibly in batches. When batches are used, the model parameters are updated per batch. This approach allows for efficient use of computational resources and can help improve the speed of the training process.

The Model Trainer 303 also incorporates a validation strategy, which uses separate validation data to validate the training process. This validation process can help ensure that the model is learning effectively and is not overfitting or underfitting the training data. The Model Trainer 303 also stores intermediate values of model parameters, which can be useful for troubleshooting, tuning, or analyzing the training process.

To determine when to stop the training process, the Model Trainer 303 uses a stopping strategy. This could be based on a variety of criteria, such as a maximum number of iterations, a minimum improvement in the validation performance, or a combination of these and other factors. Once the stopping criteria are met, the Model Trainer 303 stores the last set of model parameters.

However, the specific methods and strategies used by the Model Trainer 303 can vary. For instance, different types of optimization algorithms could be used to update the model parameters. The validation strategy could be based on different performance metrics, depending on the task and the model. The stopping strategy could also be adjusted based on the specific requirements of the training process. The Output Generator 304 is a component that uses the metadata to determine the optimal set of model parameters. Once determined, this optimal set is stored in Trained Models 106. This process of utilizing metadata allows the Output Generator 304 to make informed decisions about which set of model parameters will likely yield the best performance.

However, the method by which the Output Generator 304 determines the best set of model parameters can vary. For instance, it could use a simple comparison of performance metrics, such as accuracy or loss, calculated during the validation process. Alternatively, it could use more complex methods, such as statistical tests or machine learning algorithms, to take into account other factors and make more nuanced decisions.

The Output Generator 304 could also be designed to handle different types of metadata, depending on the specifics of the training process and the model. For example, the metadata could include information about the training process, such as the number of iterations or the learning rate, or information about the model, such as the architecture or the initialization method.

The Trained Models 106, where the optimal set of model parameters is stored, could be a simple data structure, a database, or a file system. The specific format and structure of the Trained Models 106 could be designed to facilitate the retrieval and use of the stored model parameters in various contexts, such as prediction, analysis, or further training.

### Processes for Methods and Apparatus for Bounded Linear Computation Outputs

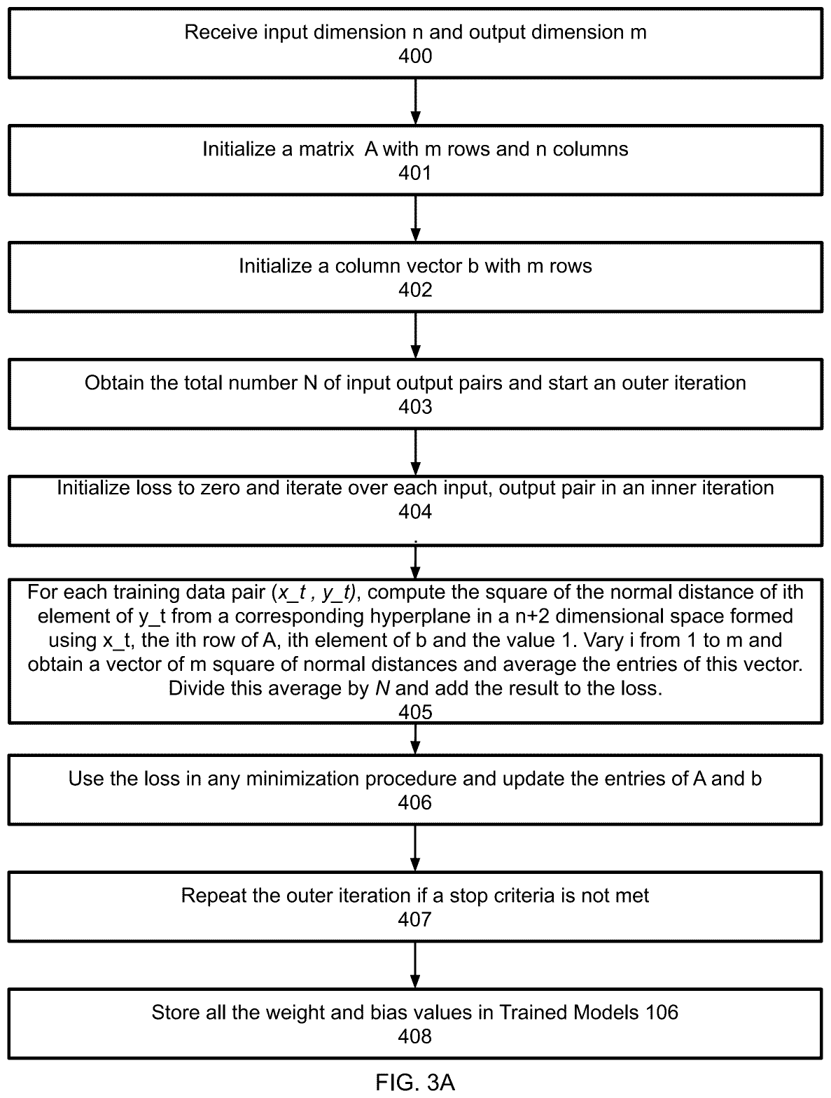

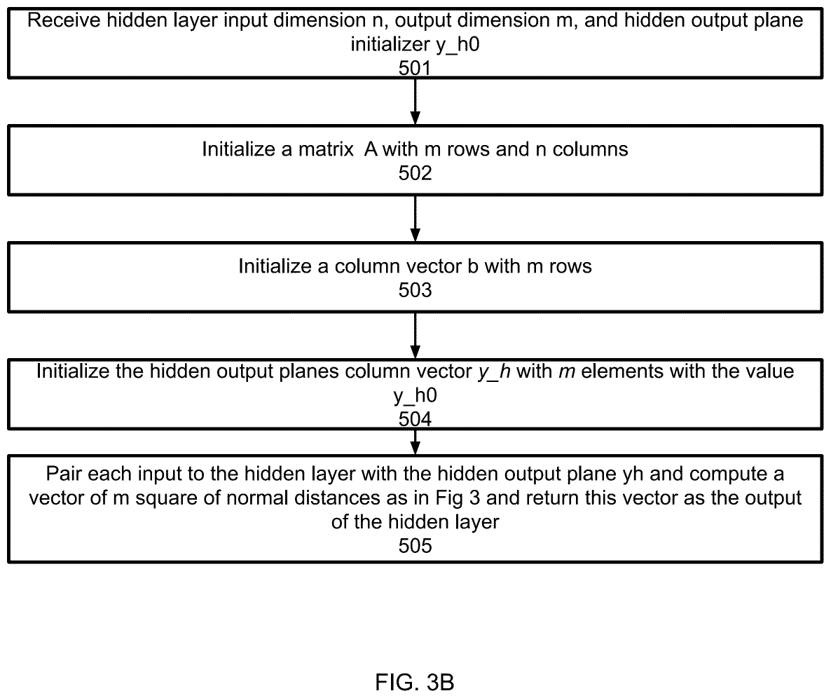

FIGS. 3A and 3B illustrate an exemplary embodiment of the methods and apparatus for bounded linear computation outputs. FIG. 3A describes an embodiment of the training method for models involving a multivariate linear regression output layer in a supervised learning setting, where a training dataset is available with a total of N data pairs where is the input and is the corresponding ground truth. Typically, both the input and the ground truth are vectors. A separate cross-validation dataset and a test dataset are also typically available. There may be zero, one or more hidden layers. The description in 3A can be understood as a description of a model without any hidden layer or as the description of the last or output layer of a model with hidden layers. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Steps 400, 401, and 402 of the method provide a systematic way to initialize the weight matrix ‘A’ and the bias vector ‘b’ of an artificial intelligence model based on the input dimension ‘n’ and the output dimension ‘m’, setting the stage for the subsequent training process. In step 403, the method receives the total count ‘N’ of training data pairs. These pairs typically consist of an input vector and a corresponding target output vector. The input vector is a point in the ‘n’-dimensional input space, and the target output vector is a point in the ‘m’-dimensional output space. The total count ‘N’ of these pairs forms the training dataset that the model will learn from.

In step 400, the method initiates by receiving two parameters: the input dimension denoted as ‘n’ and the output dimension represented as ‘m’. These dimensions are integral to the configuration of the artificial intelligence model as they define the size and structure of the input and output layers, respectively.

Following the receipt of these dimensions, the method proceeds to step 401, where it initializes a weight matrix ‘A’. This matrix is of size (m, n), meaning it has ‘m’ rows and ‘n’ columns. Each element in this matrix represents a weight, a parameter that the model will learn to adjust during the training process to optimize its performance. Initially, these weights are set to random values, a common practice in machine learning to break symmetry and ensure diverse learning paths.

Subsequently, in step 402, the method initializes a bias vector ‘b’ of size ‘m’. Each element in this vector represents a bias, another parameter that the model will learn to adjust during the training process. Similar to the weights, the biases are initially set to random values. The bias vector ‘b’ adds an extra degree of freedom to the model, allowing it to fit the training data more accurately.

As an alternative to this method, the weight matrix ‘A’ and the bias vector ‘b’ could be initialized to values other than random. For instance, they could be initialized to zero, although this is generally avoided in machine learning due to the risk of symmetric learning paths. They could also be initialized to small non-zero values, a method known as ‘Xavier initialization’ or ‘Glorot initialization’, which can help improve the speed of convergence during the training process.

In another alternative, the method could include additional steps to initialize other parameters of the model, such as learning rate or regularization parameters, depending on the specific requirements of the use case.

Step 403 of the method involves receiving the total count ‘N’ of training data pairs and initiating an outer iterative process to track the convergence of the model, setting the stage for the subsequent learning process. In step 404, the method sets a loss term to zero. The loss term is a quantitative measure of the model's performance on the training data. It is typically calculated as the difference between the model's predictions and the target outputs for the training data. By setting the loss term to zero at the beginning of each outer iteration, the method ensures that the loss for each new iteration is calculated from a clean slate.

Upon receipt of the total count ‘N’, the method initiates an outer iterative process. This process is essentially a loop that will repeat a set of operations for each iteration. The purpose of this outer iterative process is to track the convergence of the model. Convergence in this context refers to the state where the model's performance on the training data reaches an optimum, and further iterations do not significantly improve this performance.

The outer iterative process typically involves updating the weight matrix ‘A’ and the bias vector ‘b’ based on the gradients of a loss function with respect to these parameters. The loss function measures the difference between the model's predictions and the target outputs for the training data. By adjusting ‘A’ and ‘b’ to minimize this difference, the model learns to make more accurate predictions.

As an alternative, the method is designed to use different criteria to determine the convergence of the model. For example, instead of using the performance on the training data, it could use the performance on a separate validation dataset. This can help prevent overfitting, a situation where the model performs well on the training data but poorly on new, unseen data.

In another alternative, the method uses different strategies to update ‘A’ and ‘b’. For instance, it could use different optimization algorithms, such as stochastic gradient descent, mini-batch gradient descent, or more advanced methods like Adam or RMSprop. These algorithms have different trade-offs in terms of computational efficiency and convergence speed, and the choice between them would depend on the specific requirements of the use case. Steps 404 and 405 of the method involve setting a loss term to zero and starting an inner iterative process that loops over all the training data pairs, typically processing random batches of data pairs per iteration. This sets the stage for the subsequent update of the weight matrix ‘A’ and the bias vector ‘b’ based on the gradients of the loss function. In step 405, for a given training data pair (x_t, y_t), the method computes the square of the normal distance of the ith element of y_t from a corresponding hyperplane in an (n+2) dimensional space. This space is formed using x_t, the ith row of the weight matrix ‘A’, the ith element of the bias vector ‘b’, and the value 1. The normal distance is a measure of the perpendicular distance from a point to a hyperplane, and its square is often used in loss functions due to its differentiable properties and its sensitivity to outliers.

Following the initialization of the loss term, the method starts an inner iterative process according to step 405. This process is a loop that runs over all the training data pairs. The purpose of this inner iterative process is to update the weight matrix ‘A’ and the bias vector ‘b’ based on the gradients of the loss function with respect to these parameters.

Typically, the inner iterative process does not process all the training data pairs at once. Instead, it processes random batches of data pairs per iteration. This approach, known as mini-batch gradient descent, can provide a good balance between computational efficiency and convergence speed. The method ensures that each data pair is processed only once per iteration, which helps maintain the diversity of the learning paths and avoid overfitting.

In an alternative embodiment, the method is designed to process all the training data pairs at once in each inner iteration, an approach known as batch gradient descent. While this can lead to more accurate gradient estimates, it can also be more computationally intensive and slower to converge.

In another alternative embodiment, the method is designed to process only one randomly selected data pair per inner iteration, an approach known as stochastic gradient descent. While this can lead to faster convergence and can handle larger datasets, it can also lead to noisier gradient estimates and more volatile learning paths.

In yet another alternative embodiment, the method uses different strategies to select the batches of data pairs. For example, it could use stratified sampling to ensure that each batch is representative of the overall distribution of the data.

Step 405 of the method involves computing the square of the normal distance for each element of the target output vector from a corresponding hyperplane, averaging these squares, normalizing the average by the total count of training data pairs, and adding the result to the loss term. This provides a systematic way to measure the model's performance and guide its learning process. In step 406, the method applies a minimization procedure to update the entries of the weight matrix ‘A’ and the bias vector ‘b’. This procedure uses the cumulative loss computed in steps 404 and 405. The goal of this minimization procedure is to find the values of ‘A’ and ‘b’ that minimize the cumulative loss, thereby improving the model's performance on the training data.

The method varies ‘i’ from 1 to ‘m’, where ‘m’ is the output dimension. For each ‘i’, it computes the square of the normal distance as described above, resulting in a vector of ‘m’ such squares. It then averages the entries of this vector. This average represents the mean square error for the given data pair (x_t, y_t), a commonly used measure of prediction error in regression tasks.

The method then divides this average by ‘N’, where ‘N’ is the total count of training data pairs. This step normalizes the mean square error by the size of the training dataset, providing a more robust measure of the model's performance that is less sensitive to the specific size of the dataset.

Finally, the method adds the result of this division to the loss term. This step accumulates the normalized mean square error for each data pair into the overall loss term, which measures the model's performance over the entire training dataset.

In another alternative, the method could use different ways to normalize the loss. For instance, it could divide by the sum of the weights instead of the total count ‘N’, which could be useful if the data pairs are weighted or if some data pairs are more important than others.

Step 406 of the method involves using a minimization procedure that uses the cumulative loss to update the entries of ‘A’ and ‘b’. This procedure can involve back propagation to compute the gradients and the Adam optimizer to update the weights, although other techniques could also be used. In step 407, a stop criterion is employed to determine whether to continue the outer loop or terminate it. The stop criterion is a rule or set of rules that dictate when the iterative process of updating the weights and biases should cease. The choice of a suitable stop criterion can significantly impact the performance and efficiency of the learning process.

There are many minimization procedures known in the prior art that could be used for this purpose. In one embodiment, the method uses back propagation to compute the gradients of the loss term with respect to the weights. Back propagation is a widely used algorithm in the field of neural networks that efficiently computes the gradient of the loss function with respect to the weights by applying the chain rule of differentiation.

Once the gradients are computed, the method uses the Adam optimizer to update the weights. Adam, which stands for Adaptive Moment Estimation, is a popular optimization algorithm known for its efficiency and effectiveness. It combines the advantages of two other optimization algorithms, AdaGrad and RMSProp, by using both the first moments (the mean) and the second moments (the uncentered variance) of the gradients.

As an alternative to this approach, the method is designed to use other optimization algorithms to update the weights. For example, it could use stochastic gradient descent (SGD), which updates the weights based on the gradient of the loss function with respect to the weights for a single randomly selected data pair. It could also use batch gradient descent, which updates the weights based on the gradient of the loss function with respect to the weights for the entire training dataset.

In another alternative embodiment, the method uses other techniques to compute the gradients. For example, it could use numerical differentiation, which approximates the gradient by computing the change in the loss function for small changes in the weights. It could also use automatic differentiation, which computes the exact gradient by symbolically differentiating the loss function.

Step 407 of the method involves using a stop criterion to determine whether to continue the outer loop or terminate it. This stop criterion can be based on the cumulative loss for a cross-validation dataset or the number of outer iterations, among other possibilities. In step 408, following the termination of the outer loop, the method proceeds to store the model weights and biases. These weights and biases, represented by the matrix ‘A’ and vector ‘b’ respectively, are the parameters that the model has learned through the iterative process of steps 404, 405, and 406. They define the hyperplanes that the model uses to make predictions for new input data.

Numerous stop criteria known in the prior art, as would be understood by a person of ordinary skill in the art, may be used without departing from the scope of the invention. In one embodiment, a separate cross-validation dataset is used to compute a cumulative loss as described in steps 404 and 405. Cross-validation is a technique for assessing how the results of a statistical analysis will generalize to an independent dataset. It is primarily used in settings where the goal is prediction, and one wants to estimate how accurately a predictive model will perform in practice.

The cumulative loss for the cross-validation dataset is calculated in the same way as for the training dataset. If this loss is below a preset threshold, the outer iteration is terminated. This threshold can be set based on the desired accuracy of the model or other considerations.

Alternatively, the outer iteration can be terminated when the number of outer iterations exceeds a preset threshold. This threshold can be set based on the available computational resources or other considerations.

Other stop criteria could also be used. For example, the outer iteration could be terminated when the change in the cumulative loss from one iteration to the next is below a preset threshold, indicating that the model has converged to a solution. Alternatively, the outer iteration could be terminated when the change in the weights or biases from one iteration to the next is below a preset threshold, also indicating convergence.

Step 408 of the method involves storing the model weights and biases in Trained Models 106 after the termination of the outer loop. This allows the trained model to be used for making predictions for new data in the future.

The weights and biases are stored in Trained Models 106. Trained Models 106 is a storage system or repository where trained models are kept for future use. The storage can be implemented in various ways, such as in a database, a file system, or a cloud-based storage service. The stored models can be retrieved and used to make predictions for new data, without needing to retrain the model.

In addition to storing the weights and biases, the method could also store other information about the model. For example, it could store metadata about the training process, such as the number of iterations, the final value of the loss, or the values of any hyperparameters used by the model. This information can be useful for understanding the model's performance and for debugging or tuning the model.

As an alternative to storing the weights and biases in Trained Models 106, the method could store them in other locations or formats. For example, it could store them in a local file on the machine where the model is trained, or it could store them in a distributed storage system for use in a distributed computing environment. The method could also serialize the weights and biases into a format suitable for transmission over a network, for use in a client-server architecture or a cloud-based machine learning service.

### Processes for Methods and Apparatus for Bounded Linear Computation Outputs

An embodiment of the method for performing normal distance based bounded computations in a hidden layer that is not restricted to linear regression models is described in FIG. 3B. This method can be used as a replacement for any existing hidden linear layer in any model. The process steps described herein may be performed in association with a system such as that described in FIG. 1 and/or FIG. 2 above or in association with a different system. The process may comprise additional steps, fewer steps, and/or a different order of steps without departing from the scope of the invention as would be apparent to one of ordinary skill in the art.

In step 501, the method begins by receiving two specific parameters: the hidden layer input dimension ‘n’ and the hidden layer output dimension ‘m’. Broadly, at step 501 of the method involves receiving the hidden layer input dimension ‘n’, the hidden layer output dimension ‘m’, and a vector ‘y_h0’ of the coordinate values of the hidden output planes. The elements of ‘y_h0’ can be initialized to 1 or another value, and other parameters or data could also be received. In step 502, the method maintains a weight matrix ‘A’ within the hidden layer. This matrix has a size of (m, n), where ‘m’ is the hidden layer output dimension and ‘n’ is the hidden layer input dimension. The weight matrix ‘A’ holds the weights of the connections between the nodes in the input layer and the nodes in the output layer of the hidden layer.

The hidden layer input dimension ‘n’ refers to the number of nodes in the input layer of the neural network, while the hidden layer output dimension ‘m’ refers to the number of nodes in the output layer of the hidden layer. These dimensions are fundamental to the structure of the neural network, as they define the size and complexity of the model.

In addition to these dimensions, the method also receives a vector ‘y_h0’ of the coordinate values of the hidden output planes. This vector has a size ‘m’, matching the hidden layer output dimension. The coordinate values in ‘y_h0’ represent the initial state or starting point for the hidden output planes.

In one embodiment, all the elements of ‘y_h0’ can be the value 1. This is a common choice for initializing the state of a neural network, as it provides a simple and consistent starting point for the learning process. However, this is not the only possible choice for the initial state.

There are other ways to initialize the state of the neural network. For instance, the elements of ‘y_h0’ could be set to zero, another constant value, or a small random value. The choice of initial state can influence the speed and stability of the learning process, as well as the final performance of the model.

Alternatively, the method could receive additional parameters or data. For example, it could receive a learning rate for the optimization algorithm, a batch size for the training data, or a regularization parameter for the loss function. These parameters can also influence the learning process and the performance of the model. At steps 502 and 503, the method maintains a weight matrix ‘A’, a bias vector ‘b’, and a hidden output planes vector ‘y_h’ within the hidden layer. The weight matrix and bias vector are typically initialized with random values, but other initialization methods could also be used. In step 504, the method initializes the hidden output planes column vector ‘y_h’ with the vector ‘y_h0’. The vector ‘y_h0’ was previously received in step 501 and contains the initial state or starting point for the hidden output planes. By initializing ‘y_h’ with ‘y_h0’, the method sets the initial output values for the nodes in the output layer of the hidden layer. Simultaneously, the method also maintains a bias vector ‘b’ of size ‘m’. This vector holds the bias values associated with each node in the output layer of the hidden layer. The bias values are additional parameters that the model learns, which allow it to fit the training data more accurately.

In addition to the weight matrix and bias vector, the method maintains a hidden output planes vector ‘y_h’ of size ‘m’. This vector holds the output values produced by the nodes in the output layer of the hidden layer.

In step 502, the weight matrix ‘A’ and in step 503, the bias vector ‘b’ are typically initialized with random values. This random initialization is a common practice in training neural networks, as it helps to break symmetry and ensure that the model learns a diverse set of features.

However, random initialization is not the only possible method. Other initialization methods could be used, such as setting all weights and biases to a small constant value, or using a method like Xavier initialization or He initialization, which adjust the scale of the initial random weights based on the number of input and output nodes.

At step 504, the method initializes the hidden output planes column vector ‘y_h’ with the vector ‘y_h0’. The vector ‘y_h’ may remain unchanged during the training process, or it may be updated using an iterative method that involves forward propagation and back propagation. The method for updating the weights and biases can be one of the prior art methods. In step 505, a single iteration of forward propagation is applied for a given layer input vector ‘x_1’ of size ‘n’. The first action taken in this step is the augmentation of the layer input with an additional entry denoted as ‘1’. This entry represents the coordinate value of the bias dimension, effectively increasing the size of ‘x_1’ from ‘n’ to ‘n+1’.

In one embodiment, the vector ‘y_h’ remains unchanged after being initialized. This means that the output values for the nodes in the output layer of the hidden layer are fixed during the training process. This could be suitable for certain types of neural networks or learning tasks, where the output values do not need to be adjusted based on the training data.

However, the training process typically involves an iterative method for updating the weights and biases of the neural network. This iterative method includes two main steps: forward propagation and back propagation.

During forward propagation, the input data is passed through the network, and the output values are calculated based on the current weights and biases.

During back propagation, the gradients of a loss term with respect to the weights and biases are calculated. The loss term is a measure of the difference between the network's predictions and the actual values in the training data, and it depends on the specific application or learning task. The gradients of the loss term indicate how much each weight and bias should be adjusted to reduce the loss.

The gradients are then used to update the weights and biases, typically by subtracting a small fraction of the gradient from the current weight or bias. This process is repeated many times, with the weights and biases being updated after each pass through the training data.

In the present embodiment, one of the prior art methods is used for the iterative method of updating the weights and biases. This could include well-known methods such as stochastic gradient descent, batch gradient descent, or mini-batch gradient descent. It could also include more advanced methods such as RMSprop, Adam, or AdaGrad, which adjust the learning rate during the training process to improve convergence.

At step 505 involves applying one iteration of forward propagation for a given layer input vector, augmenting the input with an additional entry, combining the augmented input with the hidden output planes vector, defining (n+2) dimensional planes, and computing the normal distances of the hidden data points from these planes. The resulting vector of normal distances is then returned as the layer output.

Following this augmentation, the elements of ‘x_1’ are combined with each element of the hidden output planes vector ‘y_h’. This combination results in ‘m’ hidden data points existing in different (n+2) dimensional spaces.

Each row of the weight matrix ‘A’, the corresponding element of the bias vector, and the value ‘1’ define an (n+2) dimensional plane. The method then calculates the normal distance of each of the ‘m’ hidden data points from the corresponding hyperplane.

This process of calculating distances results in a vector of ‘m’ normal distances. This vector of distances is then returned as the layer output in step 505.

As an alternative, instead of augmenting the layer input with an additional entry of ‘1’, other constant values could be used to represent the coordinate value of the bias dimension. This would also result in an increase in the size of ‘x_1’ and could potentially affect the resulting hidden data points and their distances from the corresponding hyperplanes.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

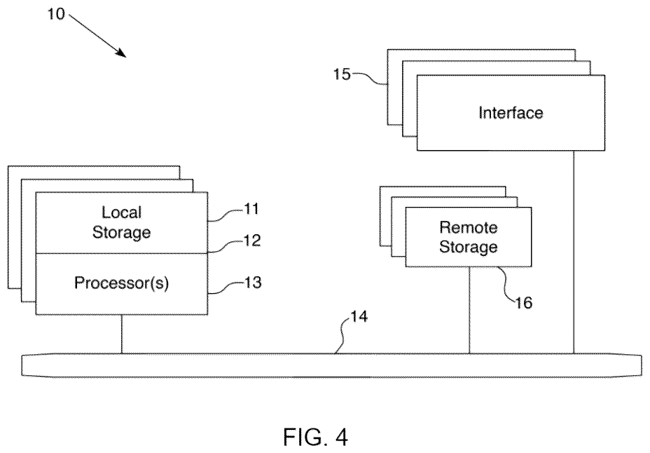

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components, process steps or the like may be and/or comprise hardware and/or software as described herein. For example, the systems, engines, and subcomponents described herein may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably.

Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

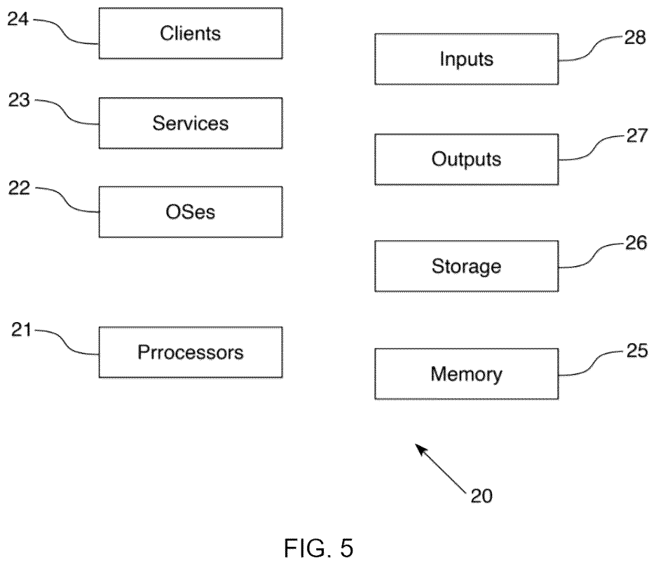

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

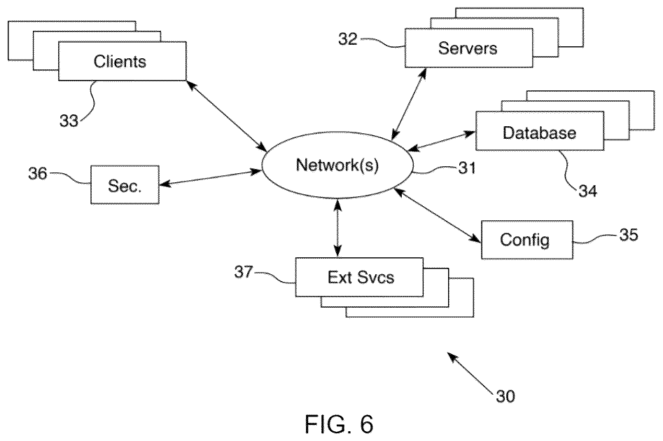

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

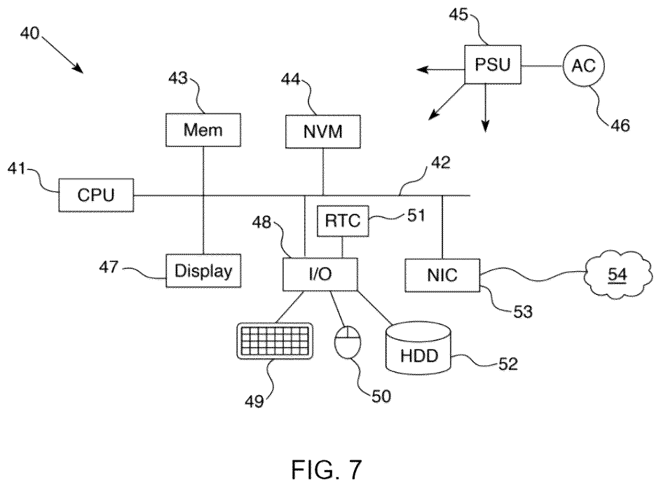

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

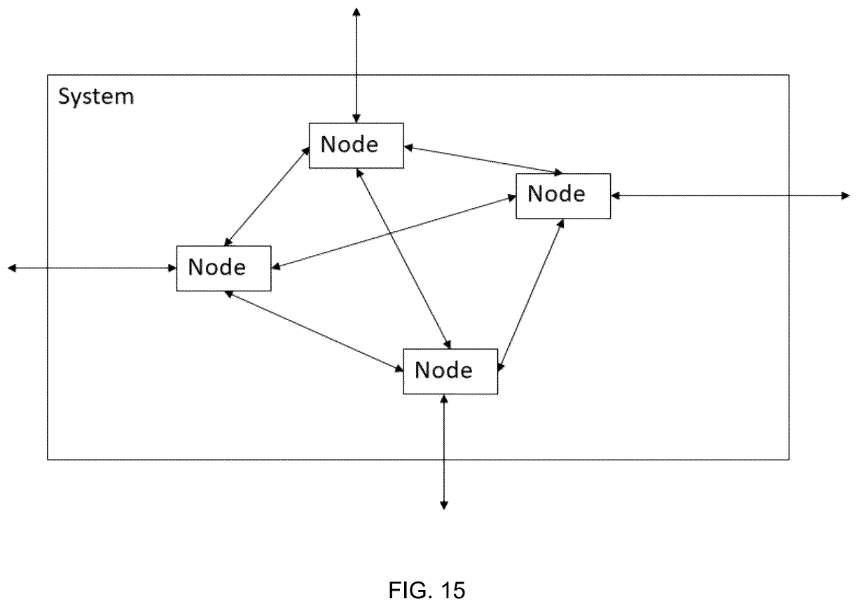

This specification describes a method for replacing the vertical distance (FIG. 15) with the normal distance to the hyperplane wherever linear computations are used in data modeling, motivated by the fact that the normal distance to a hyperplane remains finite even when the slope of the hyperplane is infinite, as long as the input vector has a finite magnitude (FIG. 2). One innovative aspect used in this specification is that in the case of layers that do not use the linear regression formulation, the bias coordinate value and the bias coefficient value are set equal to 1, which makes the bias coordinate play a similar role as the output coordinate in a linear regression layer. This invention also presents methods to limit unbounded growth of weight components.

In one aspect, the methods include computing the normal distance to a plane in n+2 dimensions for the linear regression output layer, and computing the normal distance to a plane in n+1 dimensions for layers that do not use linear regression formulation, where n is the number of inputs to a given layer excluding the bias term.

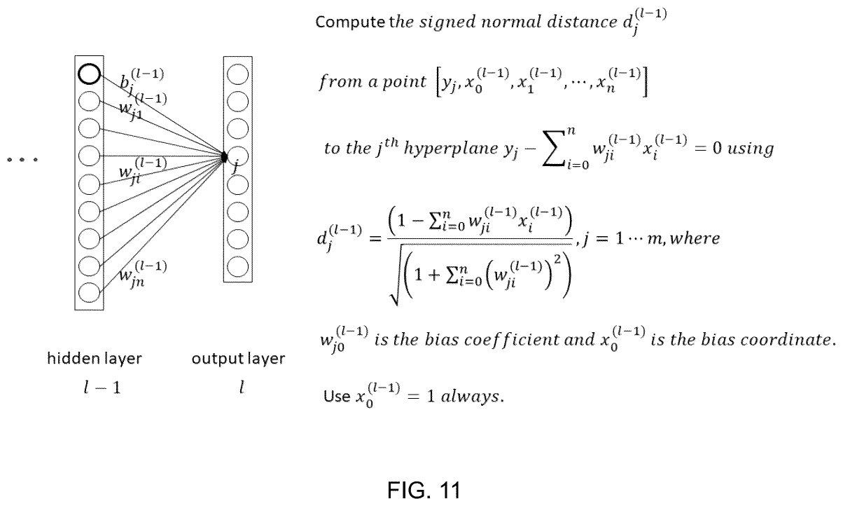

For the linear regression output layer, FIG. 11, the output dimension and the bias dimension constitute the additional two dimensions and the bias coefficient value is treated as an unknown and is computed along with other weights. Then, the magnitude or length of the normal to the (n+2) dimensional plane is computed by adding the sum of squared values of the weights to the squared value of the bias coefficient and to 1 and taking the square-root of the resulting sum. Then, the normal distance to the (n+2) dimensional plane of the output data points is computed by first computing the dot product of the weight vector with the input vector and adding the bias term, then subtracting this sum from the corresponding output data point, and finally dividing this difference by the length of the normal to the (n+2) dimensional plane.

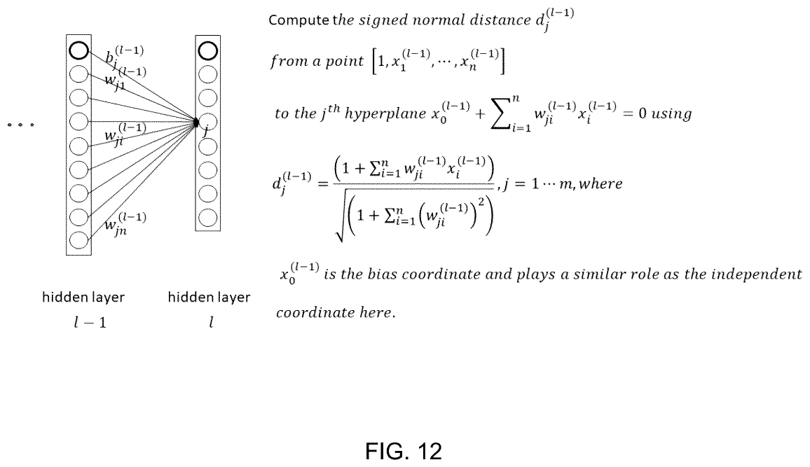

For other types of layers that do not use the linear regression formulation, FIG. 12, the bias dimension constitutes the additional dimension. For these layers, both the bias coordinate value and the bias coefficient value are set equal to 1, and the bias coordinate plays the same role as the output dimension in the linear regression output layer. For such layers, the magnitude or length of the normal to the (n+1) dimensional plane is computed by first adding the sum of the squared values of the weights to 1, and then taking the square-root of the resulting sum. Then, the normal distance to the (n+1) dimensional plane of points whose bias value is, say, 1, is computed by first computing the dot product of the weight vector with the input vector, then subtracting this product from 1, and finally dividing this difference by the magnitude of the normal to the (n+1) dimensional plane. The value 1 for the numerator is chosen as an exemplary value, as any other constant value would also serve the same purpose.

For all layers, the normal distance computed as described will remain finite regardless of the magnitude of the weights and biases, as the case may be, as long as the input vector is bounded. Since the input vector from the input layer is bounded by design, all other layers will produce bounded outputs.

Depending upon the number of inputs and the desired number of outputs at each layer, one or more hyperplanes may be defined. In one embodiment, the magnitudes of the (n+1) and the (n+2) dimensional normal vectors for each such hyperplane at each layer can be computed and stored in memory, both after weights and biases are initialized, and after each back propagation step where weights and biases are updated, in an iterative scheme. In the forward propagation step, such stored magnitudes of the normal vectors can be used to compute the normal distances to the respective hyperplanes. These normal distances would serve as drop-in replacements where vertical distances are currently used, such as in logistic regression layers, SoftMax layers, attention layers and linear hidden layers as well as convolutional layers.

Other embodiments may perform computations of both the magnitude of the normal to hyperplanes, and the normal distances of data points in the enclosing space to the hyperplanes in different orders, with different overlaps between normal length and normal distance computations (including no overlap).

Other embodiments include configuring computer programs recorded on one or more computer storage devices to perform the actions of the methods on desired computer systems and apparatus. A system comprising one or more computers or nodes can have software, firmware, hardware, or a combination thereof installed on the system and configured to perform particular operations or actions of the methods when invoked. One or more firmware or software components can be configured to perform particular operations or actions by incorporating suitable instructions that, when invoked by hardware, cause hardware to perform them. This hardware may include CPUs, GPUs, FPGAs, ASICs or other special-purpose integrated circuits.

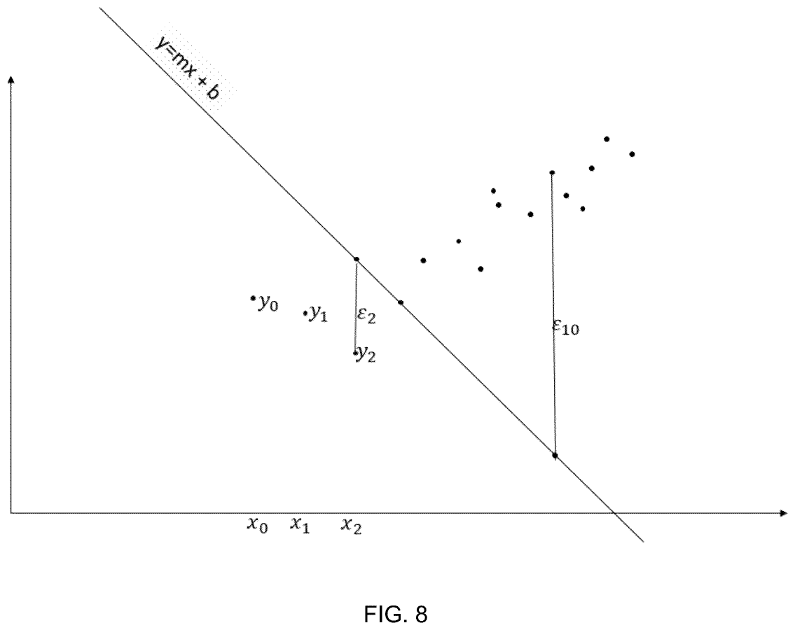

FIG. 8 illustrates the problem with classical linear regression. It shows a situation where the line of intermediate fit has a negative slope, while the line of best fit has a positive slope. As the line becomes steeper, the sum of squared distances grows unbounded. Attempts to rotate the line towards positive slope results in solution divergence due to the slope discontinuity (−inf, +inf) at θ=π/2, where θ is the angle between the x-axis and the line.

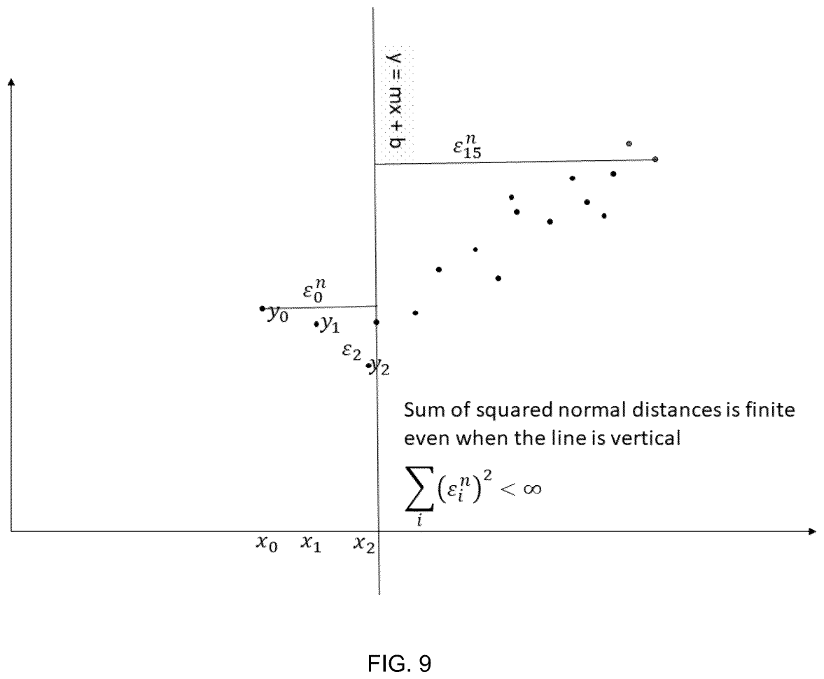

FIG. 9 shows the advantage of the normal distance-based method. The sum of squared normal distances is finite (Σᵢ (εᵢⁿ)²<∞) even when the line is vertical and the slope is infinite.

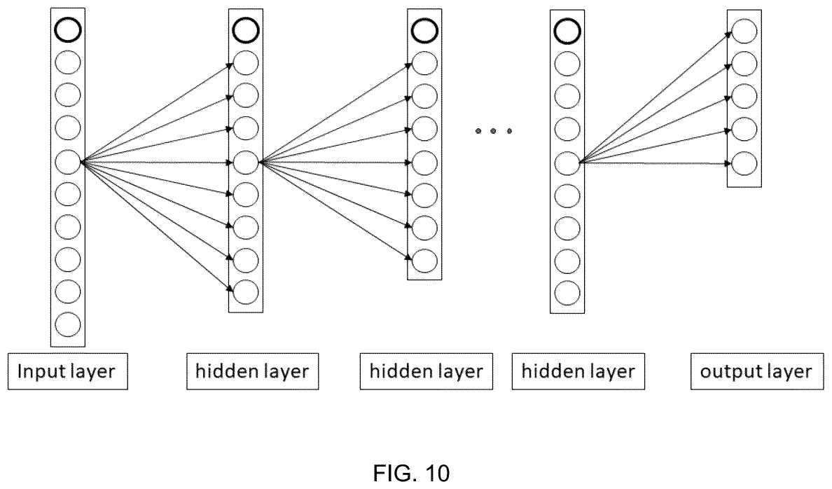

FIG. 10 shows a schematic of a Neural Network (NN), showing the input layer, output layer, and one or more hidden layers. A typical Deep Neural Network (DNN) would contain more than two hidden layers, which may have recurrent and/or residual connections. A hidden layer may contain other layers, such as attention layers and fully connected layers, or may also be comprised of convolutional layers. An output layer can be a linear regression layer, logistic regression layer, SoftMax layer, or a convolutional layer. Bias nodes are in bold. Bias nodes do not receive inputs from previous layers, but do contribute to every node in the following layer.

FIG. 11 shows the method of computing normal distances to hyperplanes from a previous layer to a linear regression output layer in a (n+2) dimensional space, where n is the number of nodes in the previous layer excluding the bias node(s). The output coordinate y and the bias coordinate x₀ form the two additional dimensions. The output layer may have m nodes and thus there would be m hyperplanes.

FIG. 12 shows the method to compute normal distances to hyperplanes between two generic layers given that the right layer is not a linear regression layer, in a (n+1) dimensional space, where n is the number of nodes in the previous layer excluding the bias node. The bias coordinate x₀ forms the additional (n+1)^{th} dimension. The bias coordinate x₀ and the bias coefficient wⱼ₀^{(l-1)} are both set equal to one. The right layer may have m nodes and thus there would be m hyperplanes.

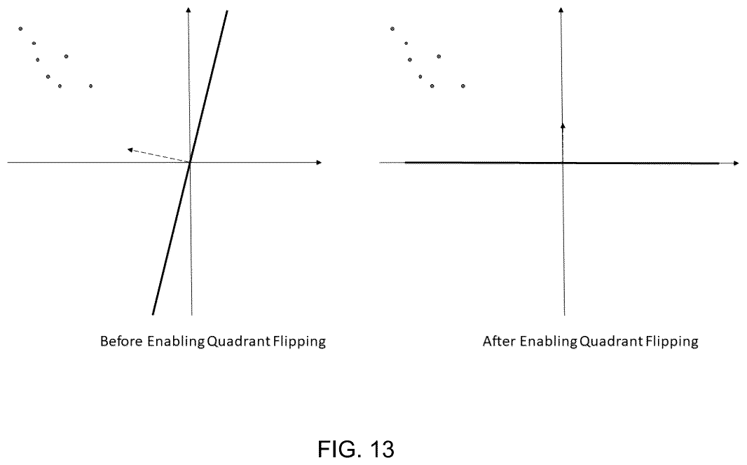

FIG. 13 shows a schematic of a hyperplane (in bold) and its normal (in dotted) before and after enabling quadrant flipping. As the hyperplane becomes nearly vertical, the magnitudes of one or more components of the weight vector grow unbounded; as the magnitude of a weight vector component exceeds a preset threshold (the “before” scenario), it is set equal to zero (the “after” scenario). In this context the weight vector includes the bias term, if it is a computed quantity.

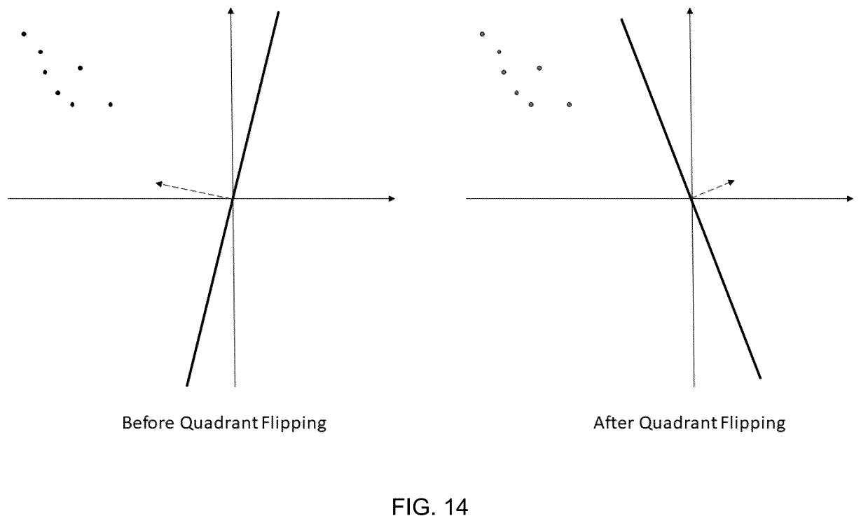

FIG. 14 shows a schematic of a hyperplane (in bold) and its normal (in dotted) before and after quadrant flipping. As the hyperplane becomes nearly vertical, the magnitudes of one or more components of the weight vector grow unbounded. As the magnitude of a weight vector component exceeds a preset threshold (the “before” scenario), its sign is flipped and its magnitude is scaled down (the “after” scenario). In this context, the weight vector includes the bias term, if it is a computed quantity.

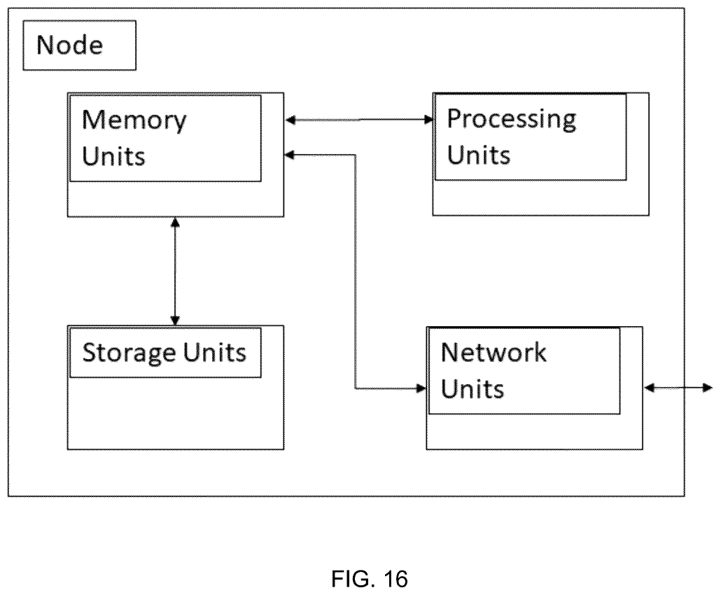

FIG. 15 shows the schematic of an exemplary system with one or more independent computing subsystems (nodes (FIG. 16)) that are interconnected to form the whole system. Arrows indicate 2-way connections between nodes and between nodes and the outside environment.

FIG. 16 shows the schematic of an exemplary node which may comprise of Processing Units, Memory Units, Storage Units and Networking Units. Computer software containing instructions to execute the methods, along with input and other data, may be stored in the Storage Units on the nodes and may be invoked when the node starts or when a node receives instructions from a user or a network.

Traditionally, minimization of linear regression has been done by measuring the distance along the dependent variable coordinate direction (called “vertical distance” henceforth) from given data points to a straight line in two dimensions, and to a hyperplane in higher dimensions. Typically, an iterative approach is used, such that the line or hyperplane is rotated incrementally until the sum of the squared vertical distances of all data points to the line is minimized, or a given stop criterion is reached. This approach, however, suffers from the fact that as the line or hyperplane becomes nearly aligned with the vertical direction, as it is rotated in the iterative process, the slope either becomes very large, tending to positive infinity, or very small, tending to negative infinity, which causes the sum of the squared vertical distances to become very large, tending to positive infinity. Thus, the iterative process diverges instead of converging.

More recently, the method of first linearly multiplying the inputs with weights and adding a bias term, and second optionally applying an element-wise non-linear activation function to this sum, is used as a building block for layers in AI/ML architectures. A schematic of a Deep Neural Network (DNN) is shown in FIG. 10. It contains one input layer, one output layer, and one or more in-between layers, called the hidden layers. In this general setting, it is possible for the output layer to be a linear regression layer, logical regression layer, SoftMax layer, or convolutional layer. A hidden layer can be a simple linear layer coupled with component-wise nonlinear activation functions, or can be a layer with inner layers comprising of (self-)attention layers, fully connected layers, residual connections and layer norm layers.

Two methods, both using the normal distance to a hyperplane, one for treating linear regression layers and one for all other types of layers, are described below.

### Linear Regression Layers

The normal distance of a point in an (n+1) dimensional space to a hyperplane can be determined in terms of the parameters of the plane. Suppose, (x₁, x₂, x₃, . . . , xₙ, y) is a point in (n+1) dimensional space where xᵢ, i=1, . . . , n are the independent variables and y is the dependent variable. Without loss of generality, a hyperplane in this space would be of the form

$$y - {\sum }_{i = 1}^{n} {w}_{i} {x}_{i} - b = 0$$

where, (w₁, w₂, w₃, . . . , wₙ, b) are unknown constants. Usually, the wᵢ, i=1, . . . , n are called the weights and b is called the bias term. In vector notations, the above equation becomes

$$y - {w}^{T} x - b = 0$$

where w=(w₁, w₂, w₃, . . . , wₙ)^{T}, x=(x₁, x₂, x₃, . . . , xₙ)^{T} are column vectors, and T denotes the transpose operation. It can be shown that the signed normal distance, y′, of a point (x₁, x₂, x₃, . . . , xₙ, y) to the hyperplane is given by

$${y}^{′} = \frac{( y - {w}^{T} x - b )}{\sqrt{1 + {‖ w ‖}^{2}}}$$

where, ∥w∥=\sqrt{w^{T}w}. Note that the bias term does not appear in the denominator. In order to address this issue, one can introduce an additional dimension x₀ and consider a hyperplane passing through the origin in (n+2) dimensions, whose equation is given by

$$y - {w}^{T} x = 0$$

where, w=(w₀, w₁, w₂, . . . , wₙ)^{T} and x=(x₀, x₁, x₂, . . . , xₙ)^{T} are n+1 dimensional column vectors. The (n+2) dimensional formulation and (n+1) dimensional formulation are equivalent when w₀x₀=b. Typically, one chooses x₀=1 and so w₀=b. Thus, taking x₀ to be always 1, the signed normal distance, y′, of a (n+2) dimensional point (1, x₁, x₂, x₃, . . . , xₙ, y) to the hyperplane is given by

$${y}^{′} = \frac{( y - {w}^{T} x )}{\sqrt{1 + {‖ w ‖}^{2}}} \qquad ( 1 )$$

where ∥w∥=\sqrt{w^{T}w}. Note that this time the ‘bias’ term w₀ appears in the denominator. Suppose there are m data points. Then, the average sum of squared normal distance, also called the loss function, would be

$$l ( {w}_{o} , {w}_{1} , {w}_{2} , … , {w}_{n} ) = \frac{1}{2 m} {\sum }_{j = 1}^{m} {[ \frac{( {y}_{j} - {w}^{T} {x}_{j} )}{\sqrt{1 + {‖ w ‖}^{2}}} ]}^{2} \qquad ( 2 )$$

where, xⱼ=(1, xⱼ₁, xⱼ₂, . . . , xⱼₙ)^{T} and w=(w₀, w₁, w₂, . . . , wₙ)^{T}. The factor 2 in the denominator in (2) is a scale factor.

In one embodiment, the system in FIG. 15 would minimize the sum of squared normal distances, as in Equation (2) above, with respect to the weights (w₀, w₁, w₂, . . . , wₙ) using software or hardware implementations. Minimization of Equation (2) differs from the traditional linear regression method, as it involves computation of the term 1+∥w∥² in the denominator. Any existing traditional linear regression implementation may be modified to compute Equation (2) by dividing its loss function computation by this term, as shown in Equation (2).

### Other Linear Layers

This section presents a method for using the normal distance to a hyperplane in other linear settings one encounters in Artificial Intelligence/Machine Learning architectures, including logical regression layers, SoftMax layers, fully connected layers, attention layers, self-attention layers, cosine similarity layers and convolutional layers. Where needed, a bias term can trivially be introduced.

In all such layers, one can use a hidden dependent variable y in the sense of linear regression and specify this hidden dependent variable in any manner. Thus, consider the hyperplane that passes through the origin and is normal to the (n+2) dimensional vector (yₕw₀, w₁, w₂, . . . , wₙ), where yₕ is the hidden dependent variable, w₀ is the bias term and (w₁, w₂, . . . , wₙ) is the weight vector:

$${y}_{h} - {\sum }_{i = 0}^{n} {w}_{i} {x}_{i} = 0 \qquad ( 4 )$$

where yₕ is set equal to 1, without the loss of any generality. Now, one can augment each input data (x₁, x₂, x₃, . . . , xₙ) with the values yₕ=1 and x₀=1 and consider the signed normal distance from the (n+2) dimensional point (1,1, x₁, x₂, x₃, . . . , xₙ) to the hyperplane in Eq (4), which is given by

$${d}_{g}^{′} = \frac{( 1 - {w}^{T} x )}{\sqrt{l + {‖ w ‖}^{2}}} \qquad ( 5 )$$

where d′_{g} is defined to be the generic linear layer normal distance. More explicitly, if there are n inputs to a hidden layer (l−1) and m outputs from the hidden layer, then, output j, would be the normal distance from hyperplane-j.

$${d}_{gj}^{′ ( l - 1 )} = \frac{( 1 - {\sum }_{i = 0}^{n} {w}_{j i}^{( l - 1 )} {x}_{i}^{( l - 1 )} )}{\sqrt{1 + {\sum }_{i = 0}^{n} {( {w}_{j i}^{( l - 1 )} )}^{2}}} , j = 1 … m$$

The system in FIG. 15 can be configured to use the normal distance in Equations (5) or (6) in any method where a linear combination of weights are used in order to always produce a bounded linear result when the input vector is bounded irrespective of whether the weights are bounded. Even in methods that don't typically use a bias term, such as the convolutional layers, the system can be configured to use the normal distance in Equation (5) to compute the hypothesis of that layer. The system can be configured to use the result of Equation (5) as an input to non-linear activation functions, as appropriate, in order to produce a final layer output.

### Handling Unbounded Growth of Weight Components

Consider the scenario of finding the solution of the linear regression problem in 2D using an iterative process. Assume that the initial line has a negative slope and the best-fit line has positive slope. Since the initial line has a negative slope, a unit tangent to this line would either lie in the second quadrant or the fourth quadrant. Now the iterative process could rotate the initial line either clockwise or counterclockwise. The next two paragraphs discuss both these scenarios respectively.

Suppose the iterative process rotates the initial line incrementally only counterclockwise. If the initial tangent was in the second quadrant, then by rotating counterclockwise it would cross the negative x-axis and would lie in the third quadrant when it matches the line of best-fit. If the initial tangent was in the fourth quadrant, then by rotating counterclockwise it would cross the positive x-axis and would lie in the first quadrant when it matches the line of best-fit. In either case, as the line crosses the x-axis, the slope of the line would change continuously. The two different orientations of the tangent vector can be obtained from each other by taking the negative of the other vector. Corresponding to each tangent vector, there is a normal vector that satisfies the right-hand rule. The two normal vectors can be obtained from each other by taking the negative of the other vector. If one negates the normal vector, then the normal distance would change sign but the magnitude would remain the same. Note that as the line crosses the x-axis, its slope would gradually become (close to) zero and then change sign.

Now consider that the iterative process rotates the initial line incrementally only clockwise. If the initial tangent was in the second quadrant, then by rotating clockwise it would attempt to cross the positive y-axis to reach the first quadrant. If the initial tangent was in the fourth quadrant, then by rotating clockwise, it would attempt to cross the negative y-axis to reach the third quadrant. In either case, as the line attempts to cross the y-axis, not only that the slope approaches −∞ it would also encounter a slope discontinuity from −∞ to ∞. No known algorithm can handle this scenario and explicitly enable the slope to jump this discontinuity to reach the other quadrant.

The above discussion carries over to higher dimensional spaces as well. In settings where an explicit dependent variable is not defined, the scenario in which weights grow unbounded implies that the weight vector is either aligned along some coordinate direction, or is attempting to rotate past a plane formed by two or more coordinate directions. These situations can be interpreted to suggest implicit linear dependency among the coordinates.

With the interpretation that an unbounded increase or decrease of a weight is an attempt to change the quadrant of the normal by crossing the dependent variable coordinate axis, and with the understanding that an alternate way to change the quadrant without encountering any numerical difficulties is to cross over the corresponding independent variable coordinate axis, the system in FIG. 15 would reset any weight whose magnitude exceeds a preset threshold to zero, as in FIG. 13. This would allow the normal to cross into either quadrant in the next iteration. An alternate strategy that an exemplary system could employ when a weight exceeds a preset threshold is to flip the sign of the weight and reduce its magnitude, as in FIG. 14. In this strategy, the factor by which to reduce the weight could be pre-defined or learnt as a hyper parameter.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented method for training models in machine learning or artificial intelligence algorithms, the computer implemented method comprising:
receiving an input dimension, the input dimension defining the size of a layer input of an artificial intelligence model;
receiving an output dimension, the output dimension defining the size of a layer output of the artificial intelligence model;
initializing a weight matrix wherein the weight matrix is sized according to the input and output dimensions, wherein each element in the weight matrix comprises a weight parameter that can be adjusted by the artificial intelligence model during training;
initializing a bias vector sized according to the output dimension, each element in the bias vector comprising a bias parameter that can be adjusted by the artificial intelligence model during training;
determining a total number of training data pairs, each pair comprising an input vector paired with an output vector;
initiating an outer iteration process, the outer iteration process operable to update at least one of the weight matrix and the bias vector based on gradients of a loss function associated with the weight matrix and bias vector parameters;
initializing a loss variable to zero;
initiating an inner iteration process, the inner iteration process operable to process a plurality of training data pairs to determine a resultant loss value, the resultant loss value determined by computing, for each of the plurality of training data pairs, the magnitude of a normal distance between a hyperplane and the output value of the training data pair;
updating at least one of the weight matrix and bias vector;
repeating the outer iteration and updating of the weight matrix and bias vector until a stop criteria is met; and
storing the updated weight matrix and bias values for the trained model.

2. The computer implemented method according to claim 1, wherein the weight matrix has a number of rows equal to the input dimension and a number of columns equal to the output dimension.

3. The computer implemented method according to claim 1, wherein each element of the weight matrix is set to an initial value, the initial value comprising a random number, zero, a value based on a Xavier initialization, or a value based on a Glorot initialization.

4. The computer implemented method according to claim 1, wherein each element of the bias vector is set to an initial value, the initial value comprising a random number, zero, a value based on a Xavier initialization, or a value based on a Glorot initialization.

5. The computer implemented method according to claim 1, wherein the loss function measures the difference between predictions by the artificial intelligence model and target outputs for associated training data.

6. The computer implemented method according to claim 1, wherein the stop criteria comprises satisfaction of a minimization criteria as determined by a minimization algorithm.

7. The computer implemented method according to claim 1, wherein the resultant loss value is computed by summing a plurality of loss values associated with the inner iteration process.

8. The computer implemented method according to claim 1, wherein the normal distance is computed from a hyperplane in a dimensional space size equal to the size of the input dimension plus 2.

9. The computer implemented method according to claim 1, wherein the normal distance to the hyperplane is computed using the input value of the training data pair, a row of the weight matrix corresponding to an iteration value of the inner iteration process, a value of the bias vector corresponding to the iteration value and a constant value.

10. The computer implemented method according to claim 1, wherein the normal distance is computed by computing the dot product between a weight vector and the input vector, the weight vector corresponding to a row of the weight matrix corresponding to an iteration value of the inner iteration, adding the corresponding bias term from the bias vector to the dot product, and subtracting this sum from the corresponding output data point to compute a difference value.

11. The computer implemented method according to claim 10, further comprising computing the magnitude of the normal to each hyperplane by adding the sum of squared values of the weights to the squared value of the bias term and then adding a constant value to generate a resulting sum, and computing the square root of the resulting sum.

12. The computer implemented method according to claim 11, further comprising dividing the difference value by the magnitude of the normal.

13. The computer implemented method according to claim 12, summing the difference value divided by the magnitude of the normal for a plurality of training data points and corresponding hyperplanes and adding this sum to the loss vector.

14. The computer implemented method according to claim 12, averaging the difference value divided by the magnitude of the normal across a plurality of training data points and corresponding hyperplanes and adding this average value to the loss vector.

15. The computer implemented method according to claim 1, wherein the layer input and layer output are associated with a regression layer of the artificial intelligence model or a hidden layer of the artificial intelligence model.

16. The computer implemented method according to claim 1, further comprising applying an activation function to each normal distance value to produce an output vector.

17. The computer implemented method according to claim 16, further comprising initializing a hidden output planes column vector sized according to the output dimension and defining an initial value for each element in the hidden output planes vector, the hidden output planes vector defining the hyperplane used in computing the normal distance.

18. The computer implemented method according to claim 1, further comparing a magnitude of each weight and bias component against a threshold and resetting the component to zero when the threshold is exceeded.

19. A computing system for training models in machine learning or artificial intelligence algorithms, the computing system comprising:
at least one computing processor; and
memory comprising instructions that, when executed by the at least one computing processor, enable the computing system to:
receive an input dimension, the input dimension defining the size of a layer input of an artificial intelligence model;
receive an output dimension, the output dimension defining the size of a layer output of the artificial intelligence model;
initialize a weight matrix wherein the weight matrix is sized according to the input and output dimensions, wherein each element in the weight matrix comprises a weight parameter that can be adjusted by the artificial intelligence model during training;
initialize a bias vector sized according to the output dimension, each element in the bias vector comprising a bias parameter that can be adjusted by the artificial intelligence model during training;
determine a total number of training data pairs, each pair comprising an input vector paired with an output vector;
initiate an outer iteration process, the outer iteration process operable to update at least one of the weight matrix and the bias vector based on gradients of a loss function associated with the weight matrix and bias vector parameters;
initialize a loss variable to zero;
initiate an inner iteration process, the inner iteration process operable to process a plurality of training data pairs to determine a resultant loss value, the resultant loss value determined by computing, for each of the plurality of training data pairs, the magnitude of a normal distance between a hyperplane and the output value of the training data pair;
update at least one of the weight matrix and bias vector;
repeat the outer iteration and updating of the weight matrix and bias vector until a stop criteria is met; and
store the updated weight matrix and bias values for the trained model.

20. A computer readable medium comprising instructions that when executed by a processor enable the processor to execute a method for training models in machine learning or artificial intelligence algorithms, the method comprising:
receiving an input dimension, the input dimension defining the size of a layer input of an artificial intelligence model;
receiving an output dimension, the output dimension defining the size of a layer output of the artificial intelligence model;
initializing a weight matrix wherein the weight matrix is sized according to the input and output dimensions, wherein each element in the weight matrix comprises a weight parameter that can be adjusted by the artificial intelligence model during training;
initializing a bias vector sized according to the output dimension, each element in the bias vector comprising a bias parameter that can be adjusted by the artificial intelligence model during training;
determining a total number of training data pairs, each pair comprising an input vector paired with an output vector;
initiating an outer iteration process, the outer iteration process operable to update at least one of the weight matrix and the bias vector based on gradients of a loss function associated with the weight matrix and bias vector parameters;
initializing a loss variable to zero;
initiating an inner iteration process, the inner iteration process operable to process a plurality of training data pairs to determine a resultant loss value, the resultant loss value determined by computing, for each of the plurality of training data pairs, the magnitude of a normal distance between a hyperplane and the output value of the training data pair;
updating at least one of the weight matrix and bias vector;
repeating the outer iteration and updating of the weight matrix and bias vector until a stop criteria is met; and
storing the updated weight matrix and bias values for the trained model.
